(19) United States
(12) Patent Application Publication
(10) Pub. No.: US 2016/0089703 A1
(43) Pub. Date: Mar. 31, 2016

(54) Sewer Jetter

(71) Applicant: Mesa Diversified LLC., Sunrise Beach, TX (US)

(72) Inventor: Paul G. Del Piero, Sunrise Beach, TX (US)

(21) Appl. No.: 14/823,270

(22) Filed: Aug. 11, 2015

Related U.S. Application Data
(60) Provisional application No. 62/057,378, filed on Sep. 30, 2014.

(51) Int. Cl. B08B 9/032; E03F 9/00

(52) U.S. Cl. CPC B08B 9/0321; E03F 9/002

(57) ABSTRACT

A sewer jetter apparatus is provided. The sewer jetter apparatus may include a sewer jetter attachment and a sewer jetter hose. A coating is provided over a joint formed by the sewer jetter attachment and the sewer jetter hose. The coating provides a smooth sloped transition between the sewer jetter attachment and the sewer jetter hose. The coating enables improved performance of the sewer jetter apparatus during retraction of the sewer jetter apparatus from a pipe. In one embodiment, the coating may be formed by a heat shrink Teflon tubing formed on at least a portion of a sewer jetter attachment ferrule and a portion of the sewer jetter hose.

This application claims priority to Provisional Patent Application No. 62/057,378 filed Sep. 30, 2014, the disclosure of which is expressly incorporated herein by reference.

### TECHNICAL FIELD OF THE INVENTION

This application relates to mechanisms for removing clogs, obstructions and other unwanted material from drains, pipes, sewer lines and the like, and more particularly this application relates to sewer jetters.

### BACKGROUND

Sewer jetters are known apparatus utilized for removing clogs, obstructions and other unwanted material from drains, pipes, sewer lines and the like. Sewer jetters clean lines through the use of pressurized fluids. An exemplary sewer jetter is shown in FIG. 1. A sewer jetter 100 is shown having a pressure source 102, a hose 104 and a sewer jetter attachment 106. Exemplary pressure sources may include commercial or residential grade pressure washers. Such pressure washers may include, for example, gas or electric pressure washers and hot or cold water pressure washers. The concepts described herein are advantageous irrespective of the type of pressure washer utilized and the concepts are not limited to any particular pressure washer. Highly pressurized fluid is provided through the hose 104 to the sewer jetter attachment 106. The sewer jetter attachment may include nozzle openings that provide the fluid at a high pressure in a manner that clogs and obstructions and the like may be dislodged and/or broken apart.

### SUMMARY OF THE INVENTION

As disclosed herein, an improved sewer jetter is provided. More particularly, it has been recognized that after insertion into a line to be cleaned, when the sewer jetter hose is retracted back out of the pipe, the sewer jetter attachments on the end of the sewer jetter hose may get caught on cracks, holes or non-uniformities in the pipe. In particular, portions of the sewer jetter may get “caught” or “hung up” on such pipe non-uniformities in a manner that hinders easy removal of the sewer jetter hose from the pipe and in extreme circumstances may result in the sewer jetter hose having to be cut in order to disengage the sewer jetter hose from the non-uniformity.

In order to address the problems described above, the concepts disclosed herein provide an improved joint between the sewer jetter hose and the sewer jetter attachment that is attached to an end of the sewer jetter hose. The improved joint is obtained through the use of an outer coating that spans the joint in order to minimize any lip or ridge at the joint that may engage the pipe non-uniformities. The outer coating lessens or minimizes the lip or ridge formed at the joint of the sewer jetter attachment and the sewer jetter hose. In this manner, the coating converts the abrupt steep lip or ridge formed at the intersection of the sewer jetter attachment and sewer jetter hose to a less abrupt and now sloped transition between the sewer jetter attachment and the sewer jetter hose. The sloped transition provides a sewer jetter system that is less likely to be caught or hung up when retracted. The coating may also provide a “slicker” smooth surface that provides additional improvement in minimizing catching and hanging up of the sewer jetter attachment. Thus, in one exemplary embodiment, the coefficient of friction of the coating may be less than at least some of the underlying materials.

In one embodiment the outer coating may be formed through the use of sleeve placed around the lip or ridge formed between the sewer jetter attachment and the sewer jetter hose. In yet another embodiment, the sleeve may be a thermoplastic. In yet another embodiment, the thermoplastic may be heat shrink tubing. The heat shrink tubing may be subject to a heating process. The result of such heating process may provide a thermoplastic that is tightly formed around at least a portion of the sewer jetter attachment and the sewer jetter hose such that a lip or ridge formed between the sewer jetter attachment and the sewer jetter hose is lessened or minimized.

In one embodiment, a ferrule of a sewer jetter attachment is provided in a secure manner around a sewer jetter hose. In one exemplary embodiment, the ferrule is secured to the sewer jetter hose via a process that includes at least mechanical crimping. In one exemplary embodiment, a fluorinated ethylene propylene heat shrink tubing (such as for example DuPont Teflon material) is placed over at least a portion of the ferrule and a portion of the sewer jetter hose. In such embodiment, the Teflon tubing covers the lip or ridge formed between the ferrule and the sewer jetter hose. The Teflon tubing is then subject to a heat shrinking process such that the Teflon tubing is secured to both the ferrule and the sewer jetter hose. In this manner a coating is provided over the previously sharp or steep ridge formed between the ferrule and sewer jetter hose. In this manner, the Teflon tubing converts the abrupt steep lip or ridge formed at the intersection of the sewer jetter attachment and sewer jetter hose to a less abrupt and now sloped transition between the sewer jetter attachment and the sewer jetter hose.

In another exemplary embodiment, a sewer jetter apparatus is provided. The sewer jetter apparatus includes a sewer jetter attachment and a sewer jetter hose, the sewer jetter attachment being attached to the sewer jetter hose. A coating is formed over at least a portion of the sewer jetter attachment and at least a portion of the sewer jetter hose, the coating having a sloped surface at a location of a joint between the sewer jetter attachment and the sewer jetter hose, a slope of the surface of the coating at the location of the joint being less 90 degrees. In one exemplary embodiment at least one component of the sewer jetter attachment includes a ferrule located around the sewer jetter hose.

In another exemplary embodiment, a sewer jetter apparatus is provided. The sewer jetter apparatus may include a sewer jetter attachment, the sewer jetter attachment including a ferrule. The sewer jetter apparatus may also include a sewer jetter hose, the ferrule surrounding at least a portion of the sewer jetter hose. The sewer jetter apparatus may also include a heat shrink thermoplastic formed over at least a portion of the ferrule and at least a portion of the sewer jetter hose, the thermoplastic having a sloped surface at a location of a joint between the sewer jetter attachment and the sewer jetter hose, the sloped surface lessening a ridge between the ferrule and the sewer jetter hose at the joint. In another embodiment, the thermoplastic may be Teflon FEP.

### DESCRIPTION OF THE DRAWINGS

FIG. 1 is an illustration of a sewer jetter system.

FIG. 2 is an illustration of an exemplary sewer jetter attachment and sewer jetter hose.

FIG. 2A is an illustration of the sewer jetter attachment and sewer jetter hose of FIG. 2 with the nozzle removed.

FIG. 2B is an illustration of the threaded connector and ferrule of the sewer jetter attachment and sewer jetter hose of FIG. 2.

FIG. 3 is an illustration of another exemplary sewer jetter attachment and sewer jetter hose.

FIG. 3A is an illustration of the sewer jetter attachment and sewer jetter hose of FIG. 3 with the nozzle removed.

FIG. 3B is an illustration of the threaded connector and ferrule of the sewer jetter attachment and sewer jetter hose of FIG. 3.

FIG. 4 is an illustration of the use of a sleeve in conjunction with the sewer jetter attachment and sewer jetter hose of FIG. 3.

FIG. 5 is a cross-sectional view of the sleeve, ferrule and sewer jetter hose of FIG. 4.

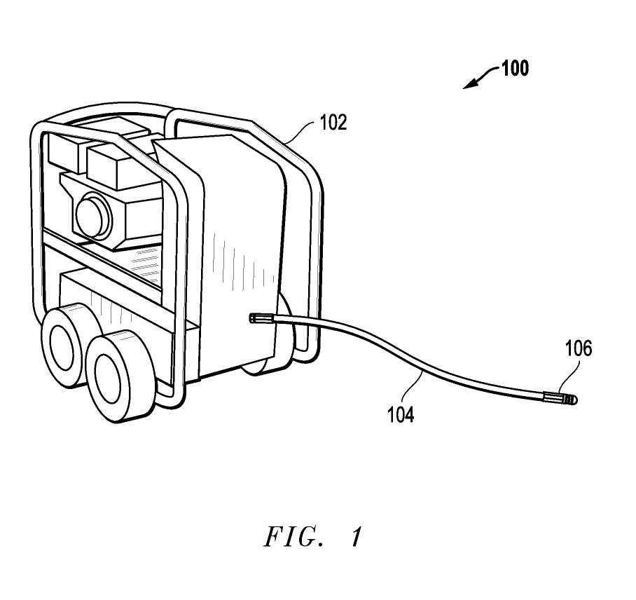

### DETAILED DESCRIPTION OF THE INVENTION

As disclosed herein, an improved sewer jetter is provided. More particularly, it has been recognized that after insertion into a line to be cleaned, when the sewer jetter hose is retracted back out of the pipe, the sewer jetter attachments on the end of the sewer jetter hose may get caught on cracks, holes or non-uniformities in the pipe. In particular, portions of the sewer jetter may get “caught” or “hung up” on such pipe non-uniformities in a manner that hinders easy removal of the sewer jetter hose from the pipe and in extreme circumstances may result in the sewer jetter hose having to be cut in order to disengage the sewer jetter hose from the non-uniformity.

In order to address the problems described above, the concepts disclosed herein provide an improved joint between the sewer jetter hose and the sewer jetter attachment that is attached to an end of the sewer jetter hose. The improved joint is obtained through the use of an outer coating that spans the joint in order to minimize any lip or ridge at the joint that may engage the pipe non-uniformities. The coating may also provide a “slicker” smooth surface that provides additional improvement in minimizing catching and hanging up of the sewer jetter attachment. Thus, in one exemplary embodiment, the coefficient of friction of the coating may be less than at least some of the underlying materials.

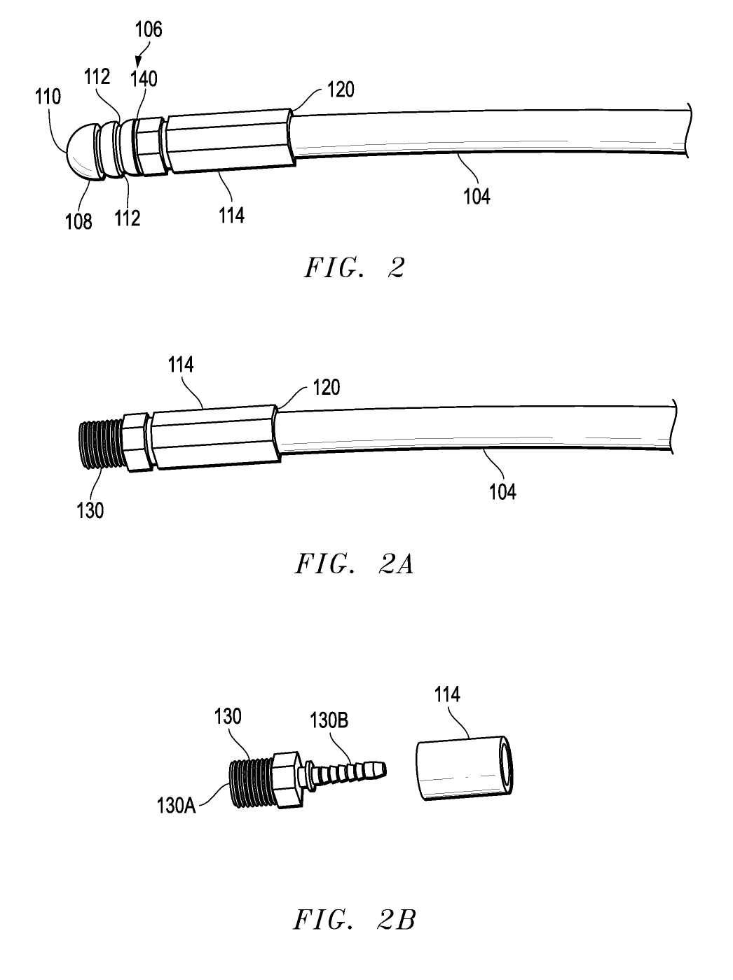

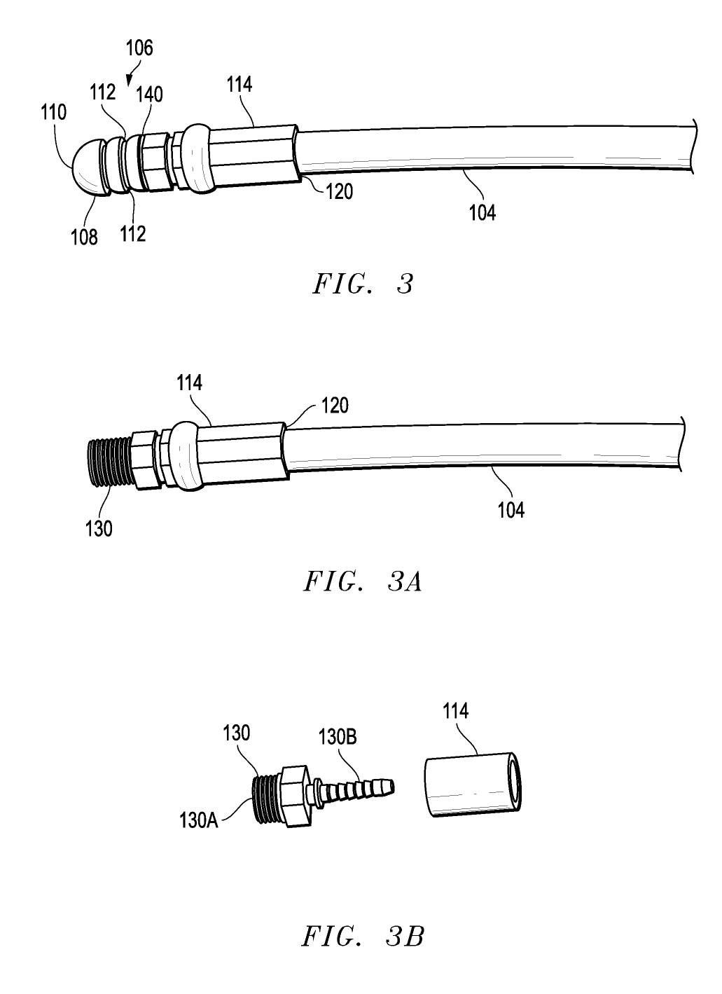

FIGS. 2 and 3 illustrate exemplary sewer jetter attachments. It will be recognized that the sewer jetter attachments shown herein and the concepts described herein may be utilized with any of a wide variety of sewer jetter attachments. As shown in FIGS. 2 and 3, a sewer jetter attachment 106 is coupled to a sewer jetter hose 104. The sewer jetter attachment may include a ferrule 114 (a ring, cap, band, sleeve, fitting or the like) that is utilized to help secure the sewer jetter attachment 106 to the sewer jetter hose 104. Though the ferrule 104 may be a separate piece from the other portions of the sewer jetter attachment 106, as used herein the ferrule is generally considered to be part of the sewer jetter attachment. A nozzle 108 is located at an end of the sewer jetter attachment 106. An o-ring 140 is provided adjacent the nozzle 108. The sewer jetter operates by provided a forward facing nozzle opening 110 through which high pressure fluid may emanate with sufficient force to provide a mechanism to breakup, remove and disrupt clogs and other obstructions (for example roots) contained within the pipe. Multiple rear facing nozzle openings 112 may also be provided. Such rear facing nozzle openings will help propel the sewer jetter attachment and hose forward through the pipe. The sewer jetter hose is typically a hose that can withstand high pressures. For example the hose may be formed from multiple layers of materials. Exemplary hoses may be a hose having an inner core formed of DuPont Hytrel thermoplastic, a braided polyester fiber jacket and a polyurethane outer cover or a hose having a synthetic rubber inner core, a steel fiber braided center jacket and a synthetic rubber outer cover. Such hoses are merely exemplary and it will be recognized that the concepts described herein are applicable to any of a wide range of hoses that may be of use in removing clogs, obstructions and other unwanted material from drains, pipes, sewer lines and the like.

As shown in FIGS. 2A and 3A, a threaded connector 130 is provided such that the nozzle 108 may be coupled to the end of the sewer jetter attachment by threadably engaging the threaded connector. As can be seen by FIGS. 2B and 3B, the threaded connector 130 includes a first end 130A for engaging with the nozzle 108 and a second end 130B for being inserted into the sewer jetter hose 104. In manufacture, ferrule 114 is placed around the sewer jetter hose 104 and the second end 130B is inserted into the sewer jetter hose 104. The ferrule 114, in one embodiment a metal piece, may then be crimped to hold the sewer jetter attachment 106 to the sewer jetter hose. Because high pressures may exist in the sewer jetter hose 104, either or both of the second end 130B and the ferrule 114 may have “teeth” that engage with the inner and outer sides of the sewer jetter hose 104 respectively to help insure that in operation the sewer jetter attachment 114 remains attached to the sewer jetter hose 104.

The exemplary mechanism described above provides a method to attach the sewer jetter attachment to the sewer jetter hose in a manner having sufficient strength to withstand the high pressures that may exist when operating the sewer jetter. Many other shapes and types of mechanisms may be utilized to couple the sewer jetter attachment to the sewer jetter hose, and the two attachments shown are shown merely for exemplary purposes as the techniques described herein are applicable to a wide range of sewer jetter attachments. Independent of the type of attachment utilized, many attachments will result in a ridge, lip, step, or other non-uniformity at the joint of the sewer jetter attachment and the sewer jetter hose such as shown by ridge 120 in FIGS. 2 and 3. Such ridges are typical of sewer jetter attachments that are utilized for high pressure applications because of the need for a very secure connection between the sewer jetter attachment and the sewer jetter hose. As mentioned above, this ridge 120 may hinder retraction of the sewer jetter hose from a pipe if during retraction the ridge 120 engages a crack, hole, non-uniformity or the like in the pipe.

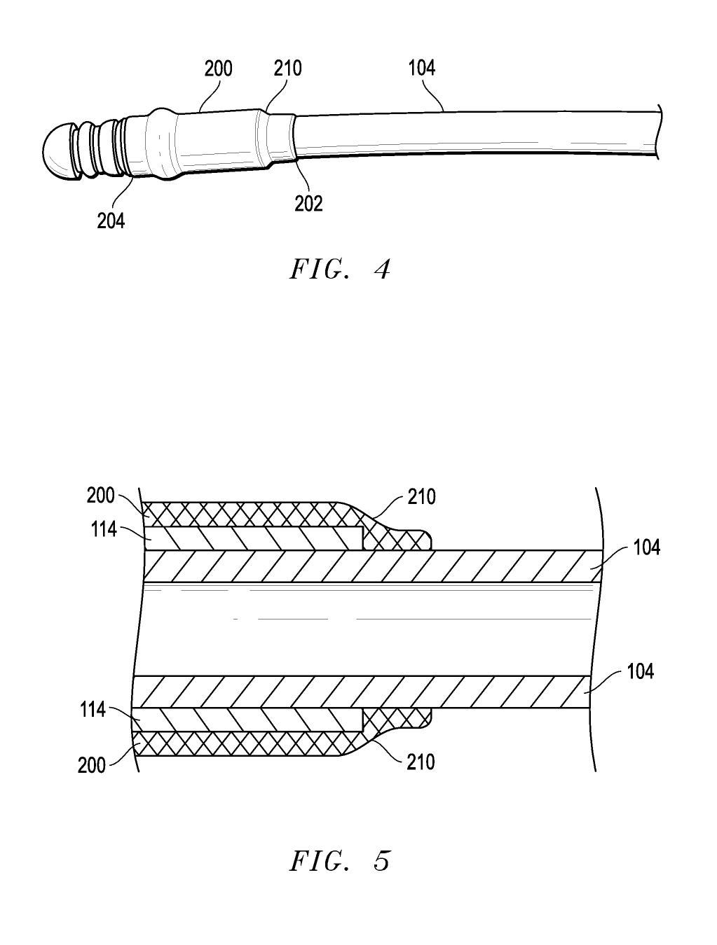

As shown in FIG. 4 the provision of a sleeve 200 over at least a portion of the ferrule 114 and the sewer jetter hose 104 minimizes the formation of ridge 120. For exemplary purposes the ferrule as configured in FIG. 3 is provided in FIG. 4. It will be recognized that the ferrule as configured in FIG. 2 may be used with the sleeve 200 or any of a wide variety of other ferrules, rings, caps, bands, sleeves, fittings or the like may be used as the sleeve 200 is not limited to use with the ferrule of FIG. 3. As shown in FIG. 4, the sleeve 200 provides a smoother joint 210 at the point where the ferrule (not seen as it is under the sleeve 200) ends. In this manner a smoother transition is provided between the ferrule and the sewer jetter hose. Though shown extending from position 202 to position 204, the sleeve 200 may be other lengths, as long as the sleeve extends over the joint region where ridge 120 was formed. In this manner, the sewer jetter attachment 106 is less likely to become engaged with pipe cracks, holes, or non-uniformities during retraction. Thus the use of sleeve 200 provides an improved sewer jetter attachment. FIG. 5 shows a cross-section of the sewer jetter hose 104, the ferrule 114 and the sleeve 200 such that a smoother joint 210 results (as compared to the ridge 120 which is formed without the sleeve 200).

As shown in FIG. 4, the sleeve 200 extends from position 202 to position 204. Such a sleeve not only covers the ridge region 120 under the joint region 210, but may provide benefits as to other lips, ridges or the like of the sewer jetter attachment 106. Thus, for example as shown in FIG. 3, other lips and ridges may exist. As shown in FIG. 4, the extension of the sleeve to position 204 provides beneficial coverage of these other lips and ridges also. Thus, the sleeve 200 may provide benefits in addition to the benefits at the ridge region 120.

The sleeve 200 may be formed in a variety of manners and of differing materials. In one non-limiting embodiment, the sleeve may be formed of heat shrink tubing. Thus, the sleeve may be located at the appropriate location so as to cover the joint formed between the ferrule 114 and the sewer jetter hose 104 and then subjected to heat so as to heat shrink the sleeve securely in place. The sleeve may be formed of a wide variety of materials. One exemplary heat shrink tubing embodiment is DuPont Teflon 9302N heat shrink tubing. Other non-limiting exemplary materials which may form sleeve 200 may be any of a variety of thermoplastics including fluoropolymers, thermoplastic polymers, neoprene, silicone elastomers and viton flouro-elastomer, including for example, but not limited to, ETFE (ethylene tetrafluoroethylene), FEP (fluorinated ethylene propylene), PFA (perfluoroalkoxy), FPM/FKM (chlorotrifluoroethylenevinylidene fluoride), MFA (perfluoro methyl alkoxy), PTFE (polytetrafluoroethylene), PVDF (polyvinylidene difluoride), THV (tetrafluoroethylene), polyolefins, PEEK (polyether ether ketone) and PVC (polyvinyl chloride). An additional benefit of using thermoplastics as the sleeve is that such materials usually provide a relative slick surface such that in addition to providing a smoother joint, the slickness of the surface will additionally aid in inhibiting the sewer jetter attachment from being “caught” or “hung up” during retraction of the sewer jetter hose from the pipe. Thus, in one exemplary embodiment, the coefficient of friction of the coating may be less than at least some of the underlying materials.

In one embodiment such as shown in FIG. 2, the sewer jetter hose may have an approximate diameter of 12.1 mm and the ferrule may have an approximate diameter of 14.8 mm, thus providing a ridge at joint 120 between the ferrule and the sewer jetter hose. Similarly, in one embodiment as shown in FIG. 3, the ferrule may have an approximate diameter of 12.8 mm (proximate the sewer jetter hose) and the sewer jetter hose may have an approximate diameter of 9.7 mm, thus providing a ridge at joint 120 between the ferrule and the sewer jetter hose. In both cases, the joint may form an abrupt approximately 90 degree step between the ferrule and the sewer jetter hose. According to one exemplary embodiment of the techniques described herein, a Teflon FEP 9302N heat shrink tubing of approximately 0.375 inches inside diameter and a wall thickness of approximately 0.020 (both measurements after heat shrinking, 0.676 inches inside diameter prior to shrinking) may be utilized to lessen the step at the joint 120. In one exemplary application the heat shrink tubing may have a length of 1.5 inches (before heat shrinking). Thus, in such a use after the application of heat, the coating at the joint will provide a slope transition between the ferrule and the sewer jetter hose, the slope being less than 90 degrees. In another embodiment the slope may be preferred to be at least less than 60 degrees. In one embodiment, the slope may be approximately at least less than 30-45 degrees. In another embodiment the slope may be equal to or less than at least 30 degrees. It will be recognized that a wide variety of other materials, components and sizes may be utilized and that those described herein are merely exemplary and not meant to limit all aspects of the techniques disclosed herein.

As mentioned above, in one embodiment the coating formed on the joint 120 may result from the use of a thermoplastic heat shrink tubing that acts as a sleeve placed around the joint 120. Any of a wide variety of heating conditions, such as temperature ranges and heating times may be utilized in a manner that provides the desired heat shrunk sleeve while not degrading the usability of the sewer jetter attachment and sewer jetter hose. As would be recognized by those in the art, the heating conditions may vary depending upon the recommendations of the thermoplastic manufacturer. For example, in one embodiment heating conditions in the range of 150 to 210 degrees C. for times of approximately 15 seconds may be utilized.

Further modifications and alternative embodiments of this invention will be apparent to those skilled in the art in view of this description. It will be recognized, therefore, that the present invention is not limited by these example arrangements. Accordingly, this description is to be construed as illustrative only and is for the purpose of teaching those skilled in the art the manner of carrying out the invention. It is to be understood that the forms of the invention herein shown and described are to be taken as the presently preferred embodiments. Various changes may be made in the implementations and structures. For example, equivalent elements may be substituted for those illustrated and described herein and certain features of the invention may be utilized independently of the use of other features, all as would be apparent to one skilled in the art after having the benefit of this description of the invention.

1. A sewer jetter apparatus comprising:
a sewer jetter attachment;
a sewer jetter hose, the sewer jetter attachment being attached to the sewer jetter hose;
a coating formed over at least a portion of the sewer jetter attachment and at least a portion of the sewer jetter hose, the coating having a sloped surface at a location of a joint between the sewer jetter attachment and the sewer jetter hose, a slope of the surface of the coating at the location of the joint being less 90 degrees.

2. The sewer jetter apparatus of claim 1, the coating being a heat shrink thermoplastic.

3. The sewer jetter apparatus of claim 2, the heat shrink thermoplastic being comprised of Teflon FEP.

4. The sewer jetter apparatus of claim 1, the sewer jetter attachment comprising at least a ferrule, the ferrule being located around at least a portion of the sewer jetter hose.

5. The sewer jetter apparatus of claim 1, at least a portion of the slope being less than 60 degrees.

6. The sewer jetter apparatus of claim 5, the coating being a heat shrink thermoplastic.

7. The sewer jetter apparatus of claim 1, the coating further being formed over a ridge or lip in the sewer jetter attachment at a location other than the joint between the sewer jetter attachment and the sewer jetter hose.

8. A sewer jetter apparatus comprising:
a sewer jetter attachment, the sewer jetter attachment including a ferrule;
a sewer jetter hose, the ferrule surrounding at least a portion of the sewer jetter hose;
a heat shrink thermoplastic formed over at least a portion of the ferrule and at least a portion of the sewer jetter hose, the thermoplastic having a sloped surface at a location of a joint between the sewer jetter attachment and the sewer jetter hose, the sloped surface lessening a ridge between the ferrule and the sewer jetter hose at the joint.

9. The sewer jetter apparatus of claim 8, the thermoplastic being Teflon FEP.

10. The sewer jetter apparatus of claim 8, at least a portion of the sloped surface being less than 60 degrees.

11. The sewer jetter apparatus of claim 10, at least a portion of the sloped surface being less than 45 degrees.

12. The sewer jetter apparatus of claim 10, the thermoplastic being Teflon FEP.

13. The sewer jetter apparatus of claim 10, the thermoplastic further being formed over a ridge or lip in the sewer jetter attachment at a location other than the joint between the sewer jetter attachment and the sewer jetter hose.

14. The sewer jetter apparatus of claim 8, the thermoplastic further being formed over a ridge or lip in the sewer jetter attachment at a location other than the joint between the sewer jetter attachment and the sewer jetter hose.

15. The sewer jetter apparatus of claim 8, the thermoplastic having a coefficient of friction less than at least one of a ferrule surface or a sewer jetter hose surface.

16. A method of forming a sewer jetter apparatus, comprising:
providing a sewer jetter attachment;
providing a sewer jetter hose;
attaching the sewer jetter attachment to the sewer jetter hose; and
placing a coating over at least a portion the sewer jetter attachment and the sewer jetter hose, the placement being such that the coating overlies a ridge between the sewer jetter attachment and the sewer jetter hose,
the coating having a sloped region to provide a smoother transition over the ridge.

17. The method of claim 16, the coating being a thermoplastic material, the method further comprising heating the thermoplastic material to form a sloped region of the thermoplastic material overlying the ridge to provide a smoother transition over the ridge.

18. The method of claim 17, the thermoplastic material being Teflon FEP.

19. The method of claim 17, the sloped region having at least a portion being sloped less than 60 degrees.

20. The method of claim 17, the thermoplastic material being a thermoplastic sleeve that surrounds a joint of the sewer jetter attachment and the sewer jetter hose.

21. The method of claim 20, the sloped region having at least a portion being sloped less than 60 degrees.
